(19) United States
(12) Patent Application Publication
(10) Pub. No.: US 2021/0342854 A1
(43) Pub. Date: Nov. 4, 2021

(54) VIRTUAL ASSISTED AGREEMENT VIDEO RECORDING

(71) Applicant: Miguel Jimenez, OREM, UT (US)

(72) Inventor: Miguel Jimenez, OREM, UT (US)

(21) Appl. No.: 17/374,438

(22) Filed: Jul. 13, 2021

(51) Int. Cl. G06Q 30/00; G06F 3/16; G06T 11/60; G06F 3/0481; H04N 7/18; H04N 5/76; G06Q 50/18; G06Q 10/10

(52) U.S. Cl. CPC G06Q 30/01; G06F 3/167; G06T 11/60; G06Q 10/101; H04N 7/185; H04N 5/76; G06Q 50/18; G06F 3/0481

(57) ABSTRACT

A system and method for assisting a service provider in explaining clauses of an agreement and generating an online agreement. The method includes the steps of providing a consumer interface to the consumer, the consumer interface presents the clauses to the consumer in text and audio form and can receive acceptance or rejection of the consumer in both click gesture and audio from the consumer. The video and audio can be recorded of the steps of presenting the clauses and receiving the response from the consumer.

### FIELD OF INVENTION

The present invention relates to a system and method for explaining an agreement, and more particularly, the present invention relates to a system and method for assisting a service provider in virtually explaining an online agreement.

### BACKGROUND

Agreement and contracts are an integral part of business transactions. The agreement and contracts, interchangeably used hereinafter, are generally legally binding and enforce duties on the parties in the agreement. Also, the agreement may include penalties and punishments for the failure to fulfill any clause or duty enforced by the agreement. Such agreements are generally drafted by professionals, such as attorneys knowing the law. Business parties review each clause before signing the agreement.

Agreements are also made between service providers and consumers in general before the consumers can avail the services. Also, agreements can be made for the supply of goods. However, due to the lengthiness and complex language of the agreements, the consumers may not read an agreement before signing. Also, the consumers lack legal expertise to review the agreement before signing. Explaining each clause of the agreement to the consumer by the service provider can become costly and time-consuming.

Later, conflicts can arise between the parties to the agreement. Enforcing the agreement can become troublesome because the consumer may not have read the clauses of the agreement.

Thus, a desire is there for a system and method that can assist the service provider to explain the terms and conditions or clauses of an agreement and ensuring that the consumer understands the clauses.

Hereinafter, the terms “agreement” and “contract” are interchangeably used. The term “clauses” refers to parts of the agreement and includes questions, terms, and conditions. The phrase “service provider” includes the supply of goods to the consumers.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that can assist a service provider to explain an agreement to a consumer.

It is another object of the present invention that the system and method can be easily adapted to the requirements of the service provider.

It is another object of the present invention that the implementation of the system can be cost-effective.

It is still another object of the present invention that the implementation of the system can be quick to set up.

It is a further object of the present invention that the system can record the consent of the consumer in audio and video format.

In one aspect, disclosed is a method for assisting a service provider in explaining clauses of an agreement to a consumer and making an online agreement, the method implemented on an agreement system, the agreement system includes a processor and a memory, the method includes the steps of: providing, by an interface module, a consumer interface on a consumer device, the consumer interface has a text frame configured to present the clauses of the agreement, a video frame configured to present a video stream from a camera coupled to the consumer device, a plurality of soft buttons configured to present a plurality of responses for the clauses, wherein each of the plurality of soft buttons configured to receive a selection by clicking of the soft button; presenting, by an agreement module, a clause of the clauses in the text frame, the agreement module implemented on the agreement system; presenting, by the agreement module, in near real-time, the video stream; presenting, by the agreement module, a plurality of responses linked to the clause as text overlay on the plurality of soft buttons; receiving, by the agreement module, the selection between the plurality of responses by clicking one of the plurality of soft buttons; and presenting a next clause or a message logically coupled to the clause. In one case, two responses can be acceptance and rejection. In one case, three responses can be acceptance, rejection, and not applicable.

In one implementation of the method, the method further includes the steps of receiving, from an admin interface presented on a service provider device, by the agreement module, logically linked clauses, wherein each clause of the clauses has two possible responses, the clauses are logically linked based on the two possible responses. The method can also provide for recording, by an AV module, a screen as a video, the screen includes the consumer interface, the AV module implemented on the agreement system; receiving, by the AV module, through a microphone coupled to the consumer device, the selection between the two responses spoken in the microphone as an audio; and combining, by the AV module, the audio with the video.

In one implementation of the method, the method further includes the steps of generating, by the agreement module, the online agreement based on the clauses and selected responses to each clause of the clauses.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the agreement system interacting with a service provider device and a consumer device through a network, according to an exemplary embodiment of the present invention.

FIG. 2 is a block diagram illustrating an architecture of the agreement system, according to an exemplary embodiment of the present invention.

FIG. 3 shows an exemplary embodiment of a consumer interface, according to an exemplary embodiment of the present invention.

FIG. 4 shows another exemplary embodiment of the consumer interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

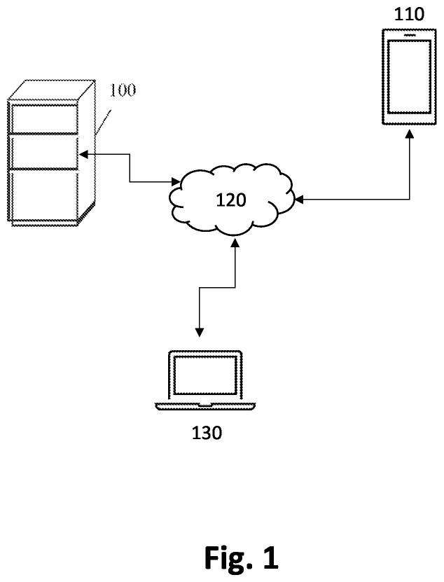

Disclosed is a virtual assistant agreement system that can assist a service provider in explaining an agreement to a consumer and recording the consent of the consumer. The disclosed system can provide for an online agreement between a service provider and a consumer. Referring to FIG. 1 is an environmental diagram showing the agreement system 100 that can interact with a consumer device 110 through a network 120. The consumer device can be a computer device with network connectivity, and examples of the consumer device may include a smartphone, laptop, desktop, tablet computer, personal digital assistant (“PDA”). The consumer device can include an operating system, such as but not limited to Android, iOS, Windows, macOS, and Linux. The consumer device can at least have an input device for receiving an input, such as a mouse or touch panel; a display; a microphone; and a camera. The consumer device can also include a network circuitry for connecting to a network. The network can be wired or wireless network. The wired network may include DSL and optical fiber lines. The wireless network may include Bluetooth®, Wi-Fi, WiMAX, and cellular networks including GPRS, LTE, CDMA, 3G, 4G, and 5G. The network can be a secure network or an unsecured network. Also, known communication protocols can be used for communicating between the consumer devices and the disclosed agreement system 100 on a network. FIG. 1 also shows the agreement system 100 interacting with a service provider device 130. The service provider device can be a computer device, and examples of the service provider device may include a smartphone, laptop, desktop, tablet computer, personal digital assistant (“PDA”). The computer device can include an operating system, such as but not limited to Android, iOS, Windows, macOS, and Linux. The computer device can have an input for receiving an input and a display for the service provider to interact with the disclosed agreement system 100. The service provider device 130 can also include a network circuitry for connecting to a network. The service provider device 130 can connect with the agreement system 100 through the network 120.

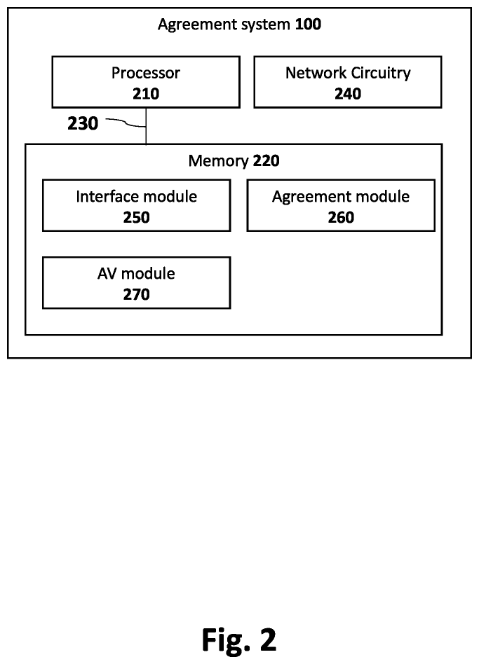

Referring to FIG. 2 which is a block diagram showing an exemplary embodiment of the agreement system 100. The agreement system 100 can include a processor 210 coupled to a memory 220 through a system bus 230. The agreement system 100 may also include a network circuitry 240 coupled to the processor through the system bus 230 for connecting the agreement system 100 to an external network. The processor 210 can be any logic circuitry that responds to and processes instructions fetched from the memory 220. Suitable examples of the processors commercially available include Intel and AMD. The memory 220 may include one or more memory chips capable of storing data and allowing any storage location to be directly accessed by the processor 210. As shown in FIG. 2, the memory can include modules according to the present invention for execution by the processor 210 to perform one or more steps of the disclosed method for virtually assisting a service provider in making an online agreement with a consumer. Memory 220 can include an interface module 250, an agreement module 260, and an AV module 270. The interface module 250 upon execution by the processor can provide an admin interface and a consumer interface. The agreement module 260 upon execution by the processor can provide generating the online agreement, and the AV module 270 upon execution by the processor can record the consumer acceptance of the agreement in audio and video form.

The interface module 250 upon execution by the processor can provide a consumer interface on the consumer device 110. The interface can be provided as application software that can be installed on the consumer device 110. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS.

In one exemplary embodiment, an admin interface can be provided by the interface module 250 on the service provider device 130. The agreement module 260 can receive details of the service provider through the admin interface. Such details of the service provider can be incorporated in the online agreement. Through the admin interface the agreement module 260 can also receive clauses of the agreement. The clauses can include statements, questions, conditions, penalties, and like known to a skilled person for incorporating into an agreement. Each clause can have two responses, such as Agree and Disagree, Yes and No, Accept and Decline, and like. The admin interface can receive the clauses of the agreement logically connected based on the possible responses to the clauses, such as acceptance and rejection of a clause. In one case, the logical connections of the clauses can involve a decision box connecting three clauses. Each decision box can have an input branch and two outputs branches based on the response.

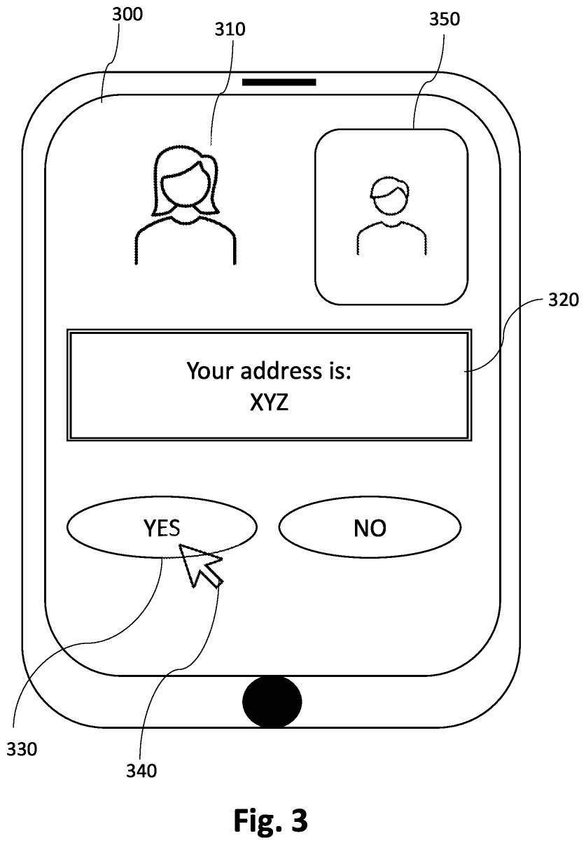

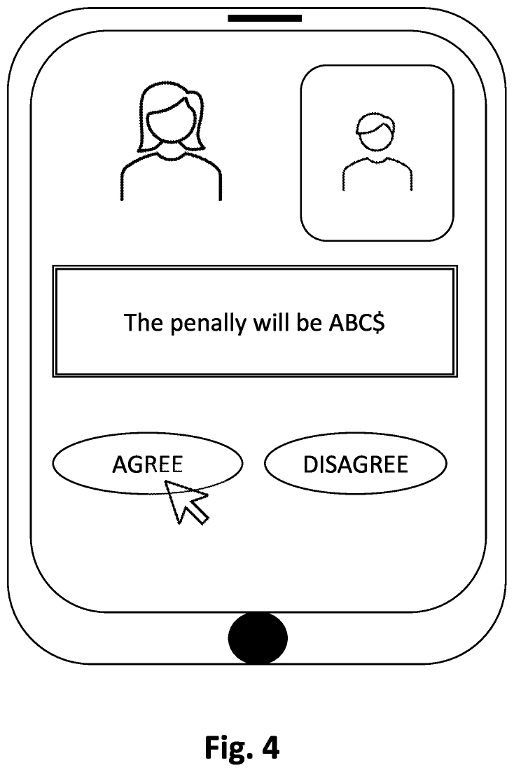

The interface module 250 can present a consumer interface on the consumer device 110. Exemplary embodiments of the consumer interface are shown in FIGS. 3 and 4. The consumer interface 300 can include an avatar 310 selected by the service provider. The avatar 310 can include animations to resemble a face while speaking. The avatar can also be referred to hereinafter as a virtual assistant. Below the avatar can be seen a text frame 320 that can present a clause of an agreement to the consumer in a printed form. Below text frame 320, can be seen two soft buttons 330 that represent the text of the response to eh clause presented in the text frame, the soft buttons can be clicked and can be linked to the clause presented in the text frame 320. The text of responses can be presented on the soft buttons. For example, FIG. 3 shows the soft buttons having the response text as “YES” and “NO”. FIG. 4 shows the soft buttons having the text as “AGREE” and “DISAGREE”. FIG. 3 also shows a video frame 350 that can display a video stream from a camera coupled to the consumer device 110.

The AV module 270 can receive the video stream from a camera coupled to the consumer device 110. The AV module 270 can also broadcast clauses through the speaker coupled to the consumer device 110. Thus, the consumer can both read and listen to the clause. Additionally, the AV module 270 can record answers or acceptance spoken by the consumer through a microphone also coupled to the consumer device 110. The AV module 270 can also record a screen that includes the consumer interface 300. Different elements of the interface including the video frame 350, movement of cursor 340, clicking gesture of the cursor on the click button, and like elements of the interface can also be recorded by the AV module 270. The screen may also include the date and time of the consumer device 110 as displayed on a display of the consumer device 110.

In one exemplary embodiment, the consumer interface 300 on the consumer device 110 can display the clauses, wherein the consumer must choose one of the two responses for the clause. Typically, the responses can be acceptance or rejection of the clause. The consumer interface 300 can also broadcast the clause to the consumer through the AV module 270. The video of the consumer while reading the clause can also be captured by the AV module 270. The consumer can click on either soft button 330 to choose the desired response to the clause. Based on the selection of the consumer, another clause or a message can be displayed to the consumer. For example, the consumer interface can display a clause that can be a question asking the consumer to confirm the address. The address can be displayed in text frame 320. The responses can be “YES” and “NO”. If the address is correct, the consumer can click the “YES” soft button, else the “NO” soft button can be clicked by the consumer. The clicking of the soft button may optionally result in the soft button appearing prominent. Both the movement of the cursor and the highlighting of the soft button can be recorded by the AV module 270. The consumer can also be required to speak the selected response. For example, while selecting “YES” the consumer can also speak “YES” in the microphone. The answer of the consumer can be recorded by the AV module 270 through the microphone. Upon selecting “YES” by the consumer, the next logically linked clause can be presented to the consumer. In case “NO” is selected by the consumer, a message can be displayed, such as “correct the address in the profile”. The consumer interface can also display a clock separate from the clock of the consumer device 110. Additionally, the location of the consumer device can also be displayed on the consumer interface 300. The location can be manually entered by the consumer or can be received from the GPS circuitry of the consumer device 110.

In one exemplary embodiment, disclosed is a method of presenting one or series of the questions to a user both presented on a screen and broadcasted through a speaker, wherein multiple responses to the questions can be presented as soft buttons and a selection between the responses can be received by selection of a soft button between the available soft buttons. The response can also be received as a spoken response, wherein the presentation of question and response can be recorder. Such a method can be useful in conducting voting.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for assisting a service provider in explaining clauses of an agreement to a consumer and making an online agreement, the method implemented on an agreement system, the agreement system includes a processor and a memory, the method comprising the steps of:
providing, by an interface module, a consumer interface on a consumer device, the consumer interface has a text frame configured to present the clauses of the agreement, a video frame configured to present a video stream from a camera coupled to the consumer device, two soft buttons configured to present two responses for the clauses, wherein each of the two soft buttons configured to receive a selection;
presenting, by an agreement module, a clause of the clauses in the text frame, the agreement module implemented on the agreement system;
presenting, by the agreement module, in near real-time, the video stream;
presenting, by the agreement module, the two responses linked to the clause as text overlay on the two soft buttons;
receiving, by the agreement module, the selection between the two responses by clicking one of the two soft buttons; and
presenting a next clause or a message logically coupled to the clause.

2. The method according to claim 1, wherein the method further comprises the steps of:
receiving, from an admin interface presented on a service provider device, by the agreement module, logically linked clauses, wherein each clause of the clauses has two possible responses, the clauses are logically linked based on the two possible responses.

3. The method according to claim 1, wherein the method further comprises the steps of:
recording, by an AV module, a screen as a video, the screen includes the consumer interface, the AV module implemented on the agreement system;
receiving, by the AV module, through a microphone coupled to the consumer device, the selection between the two responses spoken in the microphone as an audio; and
combining, by the AV module, the audio with the video.

4. The method according to claim 1, wherein the method further comprises the steps of:
generating, by the agreement module, the online agreement based on the clauses and selected responses to each clause of the clauses.

5. The method according to claim 1, wherein the two responses are acceptance and rejection.
